(19) United States
(12) Patent Application Publication
(10) Pub. No.: US 2004/0024834 A1
(43) Pub. Date: Feb. 5, 2004

(54) Sharing personal information between computing devices

(76) Inventors: Andrew Alegria, Nampa, ID (US); Brett Smith, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/211,612

(22) Filed: Aug. 2, 2002

(51) Int. Cl. G06F 15/167

(52) U.S. Cl. 709/213

(57) ABSTRACT

Systems and methods that facilitate sharing of personal information, such as contact and scheduling information, are disclosed. In one embodiment, a system and method pertains to receiving selection of personal information to be shared, copying personal information files that pertain to the selected personal information, and packaging the personal information files into an executable file that is configured to store the selected personal information into memory.

### FIELD OF THE INVENTION

The present disclosure relates to sharing personal information. More particularly, the disclosure relates to systems and methods with which information such as contact and/or scheduling information can be transferred from one computing device to another so that the information can be accessed from separate devices and/or locations.

### BACKGROUND OF THE INVENTION

Many persons now maintain a personal information database comprising contact and/or scheduling information on a computing device such as a desktop personal computer (PC). Often, such persons store copies of the information on more than one computing device.

Although such personal information can be maintained on multiple computing devices when provision is made for synchronization of the data, problems can arise when synchronization is not supported. For instance, many persons now use a PC both at work and at home. If that person further maintains personal information such as contact and/or scheduling information on both PCs, it is likely that, unless the person is particularly fastidious in updating both databases, updated information on one PC will not be stored on the other PC. For instance, if the person accepts an appointment for a future meeting while at the office and updates his or her schedule on the work PC so as to cause a reminder to activate prior to the meeting, unless the person remembers to similarly update the home PC, such a reminder will not activate on the home PC. Clearly, this could create a problem if the person works from both the office and home.

Presently, there are no convenient ways in which to update personal information such as that noted above for separate computing devices such as a work PC and a home PC. It is possible that a user could maintain separate personal information databases by manually updating them separately so as to contain the same information. For instance, the user could manually write down the information after it is entered into a first computing device so that the same information could be later entered into a second computing device. Clearly, however, this is a tedious process and defeats the purpose of maintaining the information in electronic form. In a variation on this method, the user could email the entered information or a given block of information (e.g., a particular contact) to the second computing device so that the information can be manually entered into the second computing device. Again, however, this method is unduly tedious.

Some contact/scheduling software packages facilitate copying of personal information files that contain the various personal information stored in the package. For instance, Microsoft Outlook™ maintains .PST files for each individual database that it supports. Accordingly, .PST files are provided for the “Contacts,” “Calendar,” “Inbox,” etc. databases. It is possible to make copies of these .PST files, attach them to an email message, send the message to a second computing device, open the files at the second computing device, and store the .PST files over the existing .PST files of the Outlook™ copy present on the second computing device. Although the provision of these .PST files (or other equivalent personal information files) does reduce the amount of work required to share data between two computing devices, it is relatively difficult for the average computer user to locate, identify, and select the desired .PST files. Indeed, the process is so complicated such that even computer savvy users may need to spend an undue amount of time to “figure out” where the files are and which ones pertain to the appropriate databases (e.g., contacts, schedule, etc.).

As can be appreciated from the above, it would be desirable to have a system and method with which personal information could be more easily shared between two computing devices.

### SUMMARY OF THE INVENTION

The present disclosure pertains to sharing of personal information such as contact and schedule information. Systems and methods that facilitate such sharing are disclosed. In one embodiment, a system and method pertains to receiving selection of personal information to be shared, copying personal information files that pertain to the selected personal information, and packaging the personal information files into an executable file that is configured to store the selected personal information into memory.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of an example system that facilitates sharing of personal information.

FIG. 2 is a schematic view of an example network-based system for facilitating personal information sharing.

FIG. 3 is a block diagram of a computing device shown in FIG. 2.

FIG. 4 is a flow diagram of a first example method for sharing personal information.

FIG. 5 is a flow diagram of a second example method for sharing personal information.

### DETAILED DESCRIPTION

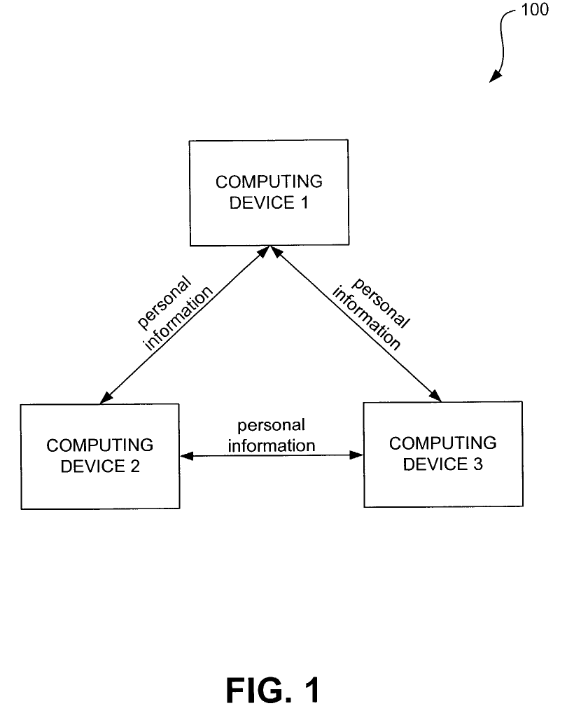

Referring now in more detail to the drawings, in which like numerals indicate corresponding parts throughout the several views, FIG. 1 illustrates a generalized system 100 for facilitating the sharing of personal information. As used in the context of this document, the term “personal information” is an inclusive term that denotes various different types of information that is typically stored using a contacts and/or scheduling software package. By way of example, this information can comprise contacts information, scheduling information, task lists, to do lists, email messages (e.g., of an “inbox,” “sent” file, “deleted” file, “saved” file, etc.), and the like.

As indicated in FIG. 1, the system 100 generally comprises two or more computing devices, in this example computing devices 1, 2, and 3. As illustrated, personal information can be shared between the computing devices. In particular, as described in greater detail below, personal information can be transmitted from one computing device to another so that the personal information can be downloaded at the other computing device as an information update. This transmission may, for instance, comprise transmission of the personal information via a network such as the Internet and, more particularly, may comprise transmitting the personal information as an attachment to an email message directed at the destination computing device.

With the arrangement summarized above, a user can, for instance, maintain up-to-date personal information on a first computing device (e.g., a work computing device) and transmit the up-to-date personal information to a second computing device (e.g., a home computing device), so that the information can be shared with the second computing device to ensure that the same information is stored by both computing devices (e.g., at both locations). This method further could be used to, for instance, transfer data from an old computing device to a new, replacement device, to copy data from a home computing device to a computing device at a new job, etc.

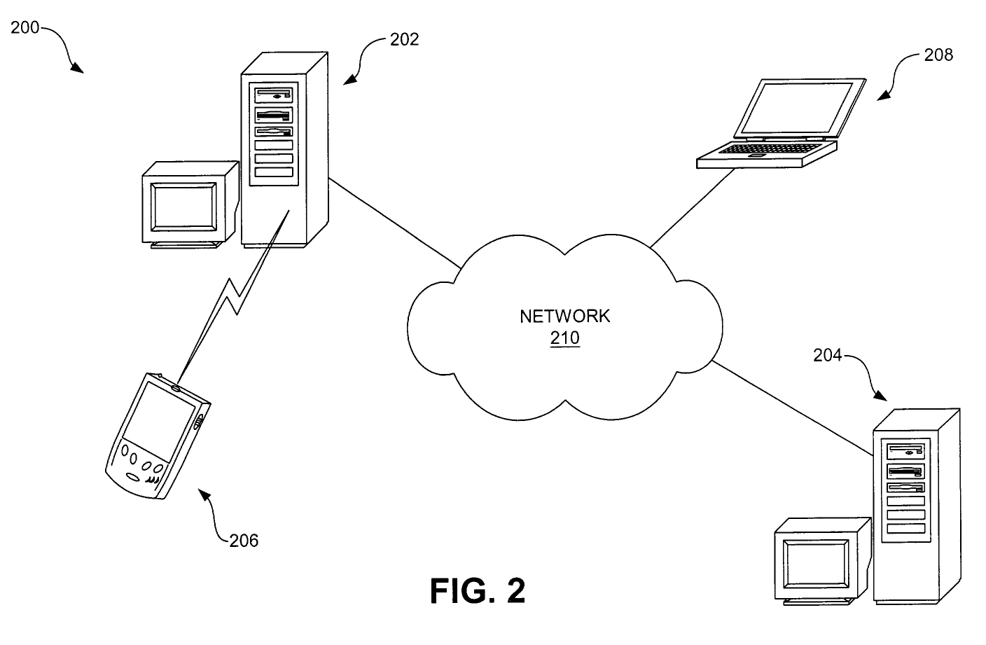

FIG. 2 illustrates an example network-based system 200 that facilitates the sharing of personal information in the manner described above with reference to FIG. 1. As indicated in FIG. 2, the system 200 can comprise a first computing device 202 and a second computing device 204. These computing devices 202, 204 may be located far away from each other. For instance, one of the devices may be located at an office location, and the other may be located at a home location. As depicted in the figure, each of these computing devices can comprise desktop personal computers (PCs). Although desktop PCs are illustrated and identified herein, it is to be understood that such PCs are only identified for purposes of discussion and that the computing devices can comprise any other computing device of the type that can maintain personal information.

In addition to the first and second computing devices 202 and 204, the system 200 can, optionally, comprise other computing devices such as computing device 206 and computing device 208. As indicated in FIG. 2, the computing device 206 can comprise, for example, a personal digital assistant (PDA) and the computing device 208 can comprise, for example, a notebook computer. Again, although particular types of computing devices are illustrated and identified, they are provided for purposes of example only for purposes of discussion. Both of these computing devices 206, 208 are portable such that they can be moved from location to location.

As indicated in the figure, the computing devices can connect to a network 210. These connections can comprise direct, i.e., wired, connections or wireless connections. In the former case, connectivity may be facilitated through a hard-wired network using a protocol such as Ethernet, or through a shared system such as a telephone and/or powerline network. In the wireless context, connectivity may be facilitated with a wireless networking protocol such as Bluetooth™ from Bluetooth SIG™ or 802.11 protocol from the Institute of Electrical and Electronics Engineers (IEEE). As will be appreciated from the discussion that follows, the precise configuration and protocol used to form the network 210 are not critical. The network 210 typically comprises one or more sub-networks that are communicatively coupled to each other. By way of example, these networks include one or more local area networks (LANs) and/or wide area networks (WANs). Indeed, in some embodiments, the network 210 may comprise a set of networks that forms part of the Internet.

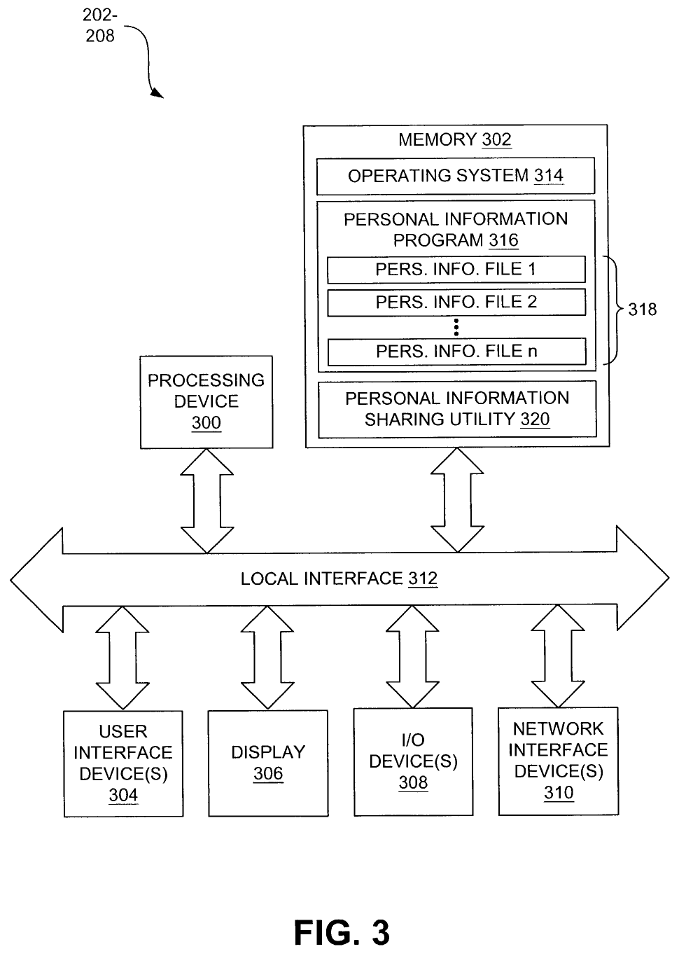

FIG. 3 is a block diagram of an example architecture for any one of the computing devices 202-208 shown in FIG. 2. Accordingly, any one of those computing devices 202-208 can be used to facilitate sharing of personal information. As indicated in FIG. 3, each computing device can, for instance, comprise a processing device 300, memory 302, one or more user interface devices 304, a display 306, one or more input/output (I/O) devices 308, and one or more network interface devices 310, each of which is connected to a local interface 312 that can comprise one or more internal and/or external buses. The processing device 300 can include any custom made or commercially available processor, a central processing unit (CPU) or an auxiliary processor among several processors associated with the computing device, a semiconductor based microprocessor (in the form of a microchip), or a macroprocessor. The memory 302 can include any one of a combination of volatile memory elements (e.g., RAM, such as DRAM, SRAM, etc.) and nonvolatile memory elements (e.g., ROM, hard disk, tape, CDROM, etc.).

The one or more user interface devices 304 comprise those components with which the user can interact with the computing device. By way of example, these components can comprise a keyboard and mouse, one or more buttons or function keys, a display, a stylus, etc. The display 306 can comprise, for instance, a computer monitor or a touch-sensitive liquid crystal display (LCD), depending upon the particular configuration of the computing device. The one or more I/O devices 308 comprise components used to facilitate connection of the computing device to other systems or devices. These I/O devices 308 can, for instance, comprise one or more serial, parallel, small system interface (SCSI), universal serial bus (USB), IEEE 1394 (e.g., Firewire™), or personal area network (PAN) connection devices.

The network interface devices 310 comprise the various components used to transmit and/or receive data over a network (e.g., network 210). By way of example, the network interface devices 310 include a device that can communicate both inputs and outputs, for instance, a network card, modulator/demodulator (e.g., modem), wireless (e.g., radio frequency (RF)) transceiver, a telephonic interface, a bridge, a router, etc.

With further reference to FIG. 3, the memory 302 comprises an operating system 314, a personal information program 316, and a personal information sharing utility 320. As shown in FIG. 3, the personal information program 316 can comprise a plurality of different personal information files 318, which each comprises various personal information. For instance, a separate personal information file 318 can be provided for each type of personal information maintained by the personal information program 316. Accordingly, there can be separate files provided for each of a contacts database, a schedule, a task list, a to do list, a collection of email messages, etc. Where the personal information program comprises Microsoft Outlook™, these personal information files 218 may comprise .PST files.

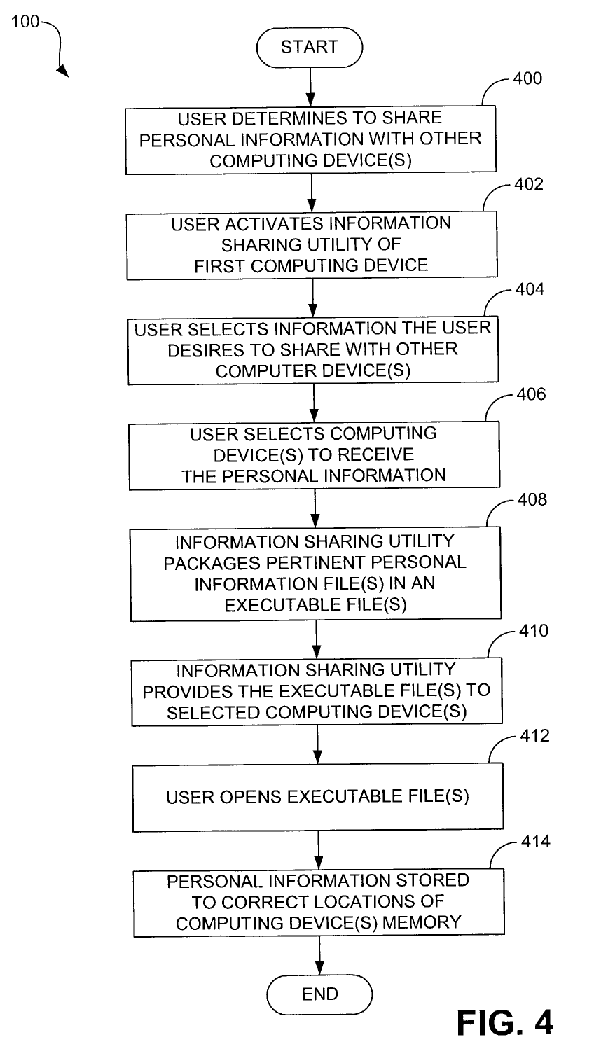

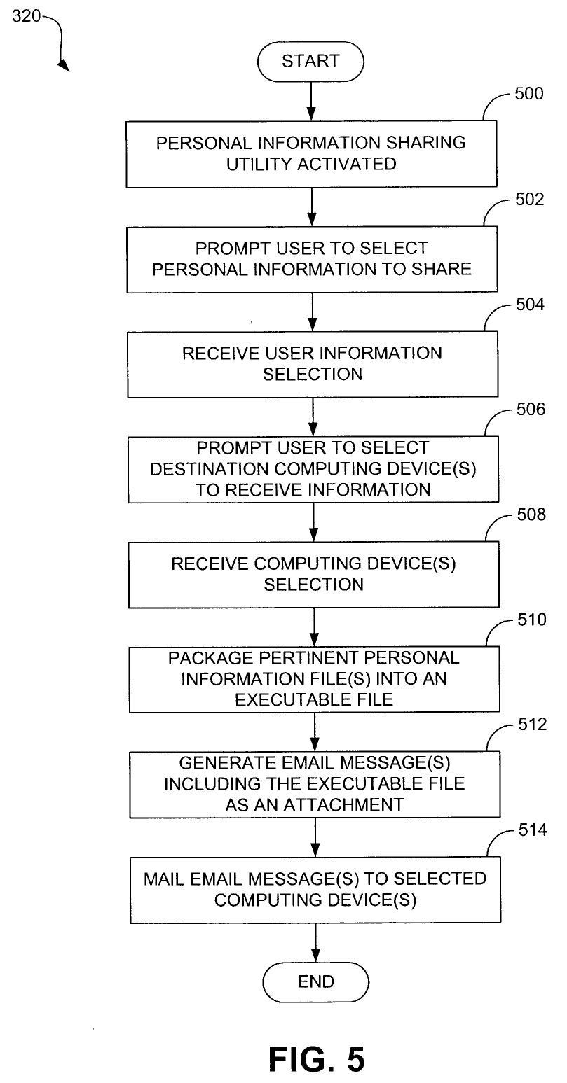

The personal information sharing utility 320 comprises a program that includes various code that is used to locate and copy personal information files for the user to simplify the task of sharing the personal information stored on the computing device and, in particular, within the personal information program 316. Operation of the personal information sharing utility 320 is described with reference to FIGS. 4 and 5 below.

Various programs and/or code (software and/or firmware) have been described herein. It is to be understood that these programs and/or code can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs and/or code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As identified above, it can be difficult to share personal information stored on one computing device with another computing device, even where personal information files are available from the personal information program that maintains the information. FIG. 4 provides an overview of one example method with which such information can be transferred from a first computing device to a second computing device.

Beginning with block 400, the computing device user first determines to share personal information stored on a first computing device with another computing device. As identified above, these computing devices can, for instance, be positioned at different locations. For example, the first computing device can be located at the user's office and the second at the user's home, or vice versa. In determining to share personal information, the user typically determines which information he or she would like to share. The nature of this information may depend upon the nature of the personal information program in which the information resides. For instance, the information may comprise one or more of contacts information, scheduling information, task lists, to do lists, email messages (e.g., of an “inbox,” “sent” file, “deleted” file, “saved” file, etc.), and the like.

The user next activates the personal information sharing utility 320, as indicated in block 402, to begin the sharing process. By way of example, activation of the utility 320 can comprise selection of an icon presented on the user desktop (i.e., of the O/S user interface), selecting an appropriate command from a start menu or other menu provided with the user interface, selecting an appropriate button presented in the personal information program user interface, selecting an appropriate command from a menu of the personal information program user interface, or the like.

Once the sharing utility 320 is activated, the user can select the particular types of information that the user would like to share with the other computing device, as indicated in block 404. Again, this information may comprise one or more of contacts information, scheduling information, task lists, to do lists, email messages (e.g., of an “inbox,” “sent” file, “deleted” file, “saved” file, etc.), and the like. By way of example, the user can simply select these types of information from a list that is presented to the user with a user interface of the personal information sharing utility 320 that appears on the display 306 of the computing device once the utility is activated.

Next, with reference to block 406, the user selects the computing device or devices to receive the selected personal information. By way of example, these devices can also be presented to the user in a list generated in the user interface if the user previously registered the computing devices with the personal information sharing utility 320 as potential destination computing devices. Such a registration process may comprise the entry of transmission information, such as a network address and/or email address associated with the destination computing device, which is used to transfer the selected personal information to the destination computing device. Where the particular destination computing device has not been previously registered with the personal information sharing utility 320, the user can, alternatively, manually provide (i.e., input) the transmission information. Notably, where the user inputs, or previously provided, a device network address, the destination computing device may need to be specifically configured to receive the personal information upon its arrival at the destination computing device. For instance, the destination computing device many comprise its own personal information sharing utility that is configured for this functionality.

Once the destination computing device has been selected, the personal information sharing utility 320, as indicated in block 408, packages the various personal information files in an executable (e.g., .EXE) file that is configured to, when activated by the user, automatically store the selected personal information files within destination computing device memory. After the personal information files have been packaged in the executable file, the information sharing utility 320 transfers the executable file to the selected computing device, as indicated in block 410. Depending upon the transmission information that has been provided to the personal information sharing utility 320 for the destination computing device, the transfer step may comprise transmitting the files directly to the computing device network address, or sending an email message to an appropriate email package that runs on the destination computing device with the executable file included as an attachment.

At this point, flow for the personal information sharing utility 320 of the first computing device is completed for the session. When the user next accesses the destination computing device, the user can then open the executable file, as indicated in block 412, for instance by double-clicking on an on-screen icon representing the file. By way of example, such an icon may be presented to the user with the destination computing device's personal information sharing utility, where the user provided a device network address and the utility received the executable file, or in an email message that was directed to an email program that runs on the destination computing device.

The executable file is then activated to, as indicated in block 414, store the various personal information to the correct locations of the destination computing device memory. Normally, this storage comprises storing the files within a file system (one or more directories) of a copy of the personal information program (i.e., the same program from which the information originated) that resides and/or executes on the destination computing device.

Turning to FIG. 5, illustrated is an example of operation of the personal information utility 320 in facilitating the transfer of personal information from one computing device to another. Beginning with block 500 of this figure, the utility 320 is activated which, as identified above, may occur in response to some action (e.g., selection) on the part of the user. Once the sharing utility 320 is activated, it can prompt the user to select the particular types of personal information that is to be transferred to the destination computing device, as indicated in block 502. By way of example, this prompting can be effected through use of a graphical user interface (GUI) that is presented to the user with the computing device display 306. In most cases, the personal information sharing utility 320 is specifically configured for use with the personal information program 316 that comprises the personal information that is to be transferred. Because of this, the personal information sharing utility 320 typically knows exactly what types of personal information the program may contain, as well as which particular personal information files (e.g., PST files) that the program may comprise. Therefore, the user typically can be presented with personal information selections that represent each type of personal information (and therefore personal information file) that the personal information program comprises.

After prompting the user for his or her selection, the personal information sharing utility 320 can receive the user selection, as indicated in block 504. Next, the utility 320 can prompt the user to select the computing device or devices to receive the selected personal information, as indicated in block 506. As noted above, these devices can be presented to the user in a list if the user had previously registered them with the utility 320 as potential destination computing devices. Alternatively or in addition, the sharing utility 320 can prompt the user to manually input appropriate transmission information (e.g., email address).

Once the destination computing device selection has been received, as indicated in block 508, the personal information sharing utility 320, as indicated in block 510, packages the various personal information files in an executable (e.g., .EXE) file in the manner described above with reference to FIG. 4. After this packaging, the information sharing utility 320 transfers the executable file to the selected computing device, as indicated in block 512. In the example of FIG. 5, this transfer comprises generating an email message that includes the executable file as an attachment, as indicated in block 512, and mailing the email message to the destination computing device, as indicated in block 514.

Again, the user can later activate the executable file on the destination computing device such that the selected personal information is stored on the destination device and, more particularly, stored in the correct locations of the copy of the personal information program that resides and/or executes on the destination computing device. Activation in this example comprises opening the email message and selecting (e.g., double-clicking) an icon that represents the attached executable file. Although the activation of the executable file could be automated, for instance automatically launching upon arrival at the destination computing device, manual activation is preferred to provide greater control over the information and its use to the user.

With the manner of operation described above with reference to FIGS. 4 and 5, personal information such as contact information, scheduling information, etc. can be more easily shared among multiple computing devices to help ensure that the most up-to-date information is present on each of a person's computing devices, even when no provision is made for formal synchronization. In that the personal information sharing utility 320, at least partially, automates the information sharing process, work required of the user and the degree of skill required of the user can be significantly reduced.

Although the disclosed systems and methods have been specifically described in the context of sharing information between computing device to ensure that the same information is stored by both (i.e., synchronization), it will be appreciated that the systems and methods can be used in many other contexts. For example, as noted above, data can be downloaded from an old computing device to a new, replacement device. In another example, data can be provided to a computing device that the use will use at a new job. Moreover, the systems and methods could be used as a back-up measure in case a first computing device fails. In such a scenario, the user can periodically transmit personal information files to another computer, e.g., via email, such that the information will still be available. Persons having ordinary skill in the art will appreciate that myriad other alternatives exist. All such alternatives are intended to fall within the scope of the present disclosure.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for facilitating sharing of personal information, comprising:
receiving selection of personal information to be shared;
copying personal information files that pertain to the selected personal information; and
packaging the personal information files into an executable file that is configured to store the selected personal information into memory.

2. The method of claim 1, wherein the step of receiving selection of personal information comprises receiving identification of various types of information stored in a personal information program.

3. The method of claim 1, wherein the step of copying personal information files comprises copying .PST files of a personal information program.

4. The method of claim 1, wherein the step of packaging the personal information files comprises packaging the personal information files into an .EXE file that is configured to, when activated by user selection, store the selected personal information into memory.

5. The method of claim 1, further comprising receiving selection of a destination for the selected personal information.

6. The method of claim 5, wherein the step of receiving selection of a destination comprises receiving selection of a network address of a destination computing device.

7. The method of claim 6, further comprising transmitting the executable file to the network address.

8. The method of claim 5, wherein the step of receiving selection of a destination comprises receiving selection of an email address of an email program that resides on a destination computing device.

9. The method of claim 8, further comprising transmitting the executable file to the email address.

10. A system for facilitating sharing of personal information, comprising:
means for receiving selection of personal information to be shared;
means for copying personal information files that pertain to the selected personal information; and
means for packaging the personal information files into an executable file that is configured to store the selected personal information into memory.

11. The system of claim 10, wherein the means for copying personal information files comprise means for copying .PST files of a personal information program.

12. The system of claim 10, wherein the means for packaging the personal information files comprise means for packaging the personal information files into an .EXE file that is configured to, when activated by user selection, store the selected personal information into memory.

13. The system of claim 10, further comprising means for transmitting the executable file to a network address of a destination computing device.

14. The system of claim 10, further comprising means for transmitting the executable file to an email address of an email program that resides on a destination computing device.

15. A personal information sharing program stored on a computer-readable medium, comprising:
logic configured to receive selection of personal information to be shared;
logic configured to copy personal information files that pertain to the selected personal information; and
logic configured to package the personal information files into an executable file that is configured to store the selected personal information into memory.

16. The program of claim 15, wherein the logic configured to copy personal information files comprises logic configured to copy .PST files of a personal information program.

17. The program of claim 15, wherein the logic configured to package the personal information files comprises logic configured to package the personal information files into an .EXE file that is configured to, when activated by user selection, store the selected personal information into memory.

18. The program of claim 15, further comprising logic configured to transmit the executable file to a network address of a destination computing device.

19. The program of claim 15, further comprising logic configured to transmit the executable file to an email address of an email program that resides on a destination computing device.

20. A method for sharing information between computing devices, comprising:
prompting a user to select personal information of a personal information program that is to be shared;
receiving selection of the personal information to be shared;
prompting the user to select a destination with which the personal information is to be shared;
receiving selection of the destination;
copying personal information files that pertain to the personal information to be shared;
packaging the personal information files in an executable file that is configured to store the selected personal information into memory; and
transmitting the executable file to the destination.

21. The method of claim 20, wherein the step of prompting the user to select a destination comprises prompting the user to select a destination computing device network address.

22. The method of claim 21, wherein the step of transmitting the executable file comprises transmitting the file to the device network address.

23. The method of claim 20, wherein the step of prompting the user to select a destination comprises prompting the user to select an email address of an email program that resides on a destination computing device.

24. The method of claim 23, wherein the step of transmitting the executable file comprises transmitting the file to the email address.

25. A computing device, comprising:
a processing device; and
memory that includes:
a personal information program that contains various personal information;
a personal information sharing utility that includes logic configured to copy personal information files of the personal information program that pertain to selected personal information and logic configured to package the personal information files in an executable file that is configured to store the personal information at a desired location.

26. The device of claim 25, wherein the personal information sharing utility further includes logic configured to transmit the executable file to a destination computing device.

27. The device of claim 26, wherein the logic configured to transmit the executable file is configured to transmit the executable file to a device network address.

28. The device of claim 26, wherein the logic configured to transmit the executable file is configured to transmit the executable file as an attachment to an email message.

29. An executable file stored on a computer-readable medium, comprising:
at least one personal information file; and
logic configured to store the at least one personal information file in at least one location within computing device memory.

30. The file of claim 29, wherein the personal information file is a .PST file.

31. The file of claim 29, wherein the logic configured to store is configured to store the at least one personal information file within a personal information program that resides within the computing device memory.

32. The file of claim 29, wherein the file is an .EXE file.
